(19) United States
(12) Patent Application Publication
(10) Pub. No.: US 2019/0202496 A1
(43) Pub. Date: Jul. 4, 2019

(54) SYSTEMS AND METHODS FOR AUTONOMOUS FRONT WHEEL STEERING

(71) Applicant: Joyson Safety Systems Acquisition LLC, Auburn Hills, MI (US)

(72) Inventors: Damir Menjak, Rochester Hills, MI (US); Ian Bublitz, Sterling Heights, MI (US); Nicky Yuen, Troy, MI (US)

(21) Appl. No.: 16/240,254

(22) Filed: Jan. 4, 2019

Related U.S. Application Data
(60) Provisional application No. 62/613,649, filed on Jan. 4, 2018.

(51) Int. Cl. B62D 6/00; G05D 1/00

(52) U.S. Cl. CPC B62D 6/002; G05D 2201/0213; G05D 1/0088; B62D 6/007

(57) ABSTRACT

A system of controlling an autonomous steering procedure in a vehicle includes a computer configured to activate modes for operating an autonomous steering program. The computer receives steering parameters from at least one vehicle sensor and an autonomous steering selection input from an operator. The automatic steering program generates a first decouple instruction corresponding to the first selected mode to a steering control assembly to decouple torque on the steering wheel and the wheels on the vehicle. In a first mode, the automatic steering program enters a continuous ready state and in another mode, the ready state is for a discrete period determined by a driver's hands on the steering wheel.

### CROSS REFERENCE TO RELATED APPLICATIONS

This application is a nonprovisional of and claims priority to provisional patent application 62/613,649, filed Jan. 4, 2018.

### BACKGROUND

FIGS. 1-4 illustrate known implementations of technology used to provide a driver of a vehicle with convenient features that make the vehicle safer to operate and more readily adjustable in real time by either a driver or a computerized control system installed in the vehicle. For example, FIG. 1 illustrates the interior cabin (10) of a vehicle and shows a common arrangement of standard components such as a seat positioned to accommodate a driver controlling the steering wheel (20) as well as numerous accessories in the vehicle cabin (10). As further shown in both FIG. 1 and FIG. 2, steering systems in modern vehicles incorporate sensors (40) that transmit control parameters via electronic data communications (29) to computers (60) installed in the vehicle. In the prior art embodiment of FIG. 2, a steering wheel (20) has been outfitted with hand sensors (40) on the surface of the steering wheel rim, and additional regions (24) of the steering wheel (e.g., along the hub (22)) also provide areas for incorporating data input sensors and/or output sensors to automate the driving experience. Accessory control buttons (23) may also be conveniently located in the steering wheel to allow the driver more options to utilize various vehicle accessory systems while driving and manipulating the steering wheel (20) to control a moving vehicle. All of the buttons (23) and sensors (40) have been implemented to transmit numerous kinds of data about the status and preferences of the driver as well as conditions within or about the vehicle. For example, sensors (40) may be used for hands-on-wheel (“HOW”) technology capable of sensing whether or not the driver is touching or gripping the steering wheel (20). The examples of FIG. 1 and FIG. 2 show discretely placed hand grip sensors (40) that can detect information about a driver's hand position and/or allow an automated computer system in the vehicle to track the driver's biometric data. As shown in FIG. 3, however, a steering wheel (20) may utilize the entire surface of the steering wheel (20) to provide regions for driver data collection, driver data input, or driver data output. For example, in one prior art embodiment of FIG. 3, the steering wheel (20) contains a device that senses capacitance/charge to determine where and when the driver has contact with the wheel. Certain regions of the steering wheel (20) may be divided into subsections (102, 103, 104, 105) that detect a driver's respective hand positions for hands-on-wheel data processing operations with a computer (60) installed in the vehicle. As noted in regard to FIG. 1, however, other parts of the steering system may also be used to automate both the driver's experience in the vehicle cabin and vehicle operation with properly placed electronics along or within the steering wheel bezel (24) or hub (22).

Other mechanisms that have been known in the art of steering systems include utilizing the above-noted steering wheel subsections (102, 103, 104, 105) to provide data collection regions for operations that monitor hands-on-wheel status while simultaneously taking advantage of modern steering wheel accessories such as steering wheel heaters installed within the steering wheel. FIG. 4 illustrates that a steering wheel system computer (60) may include data connections to processors and/or controllers (112, 116) that implement both the hands-on-wheel sensing function along with steering wheel heater operations. The computer (60) and associated electronics, therefore, utilize mutually compatible software programmed to control the heating, the hands-on-wheel data collection, and an overall power source (118) that make up part of a smart steering system. This is another example of combining various steering system technologies for appropriate output to the steering wheel and to other computer systems in the vehicle.

One area of innovation that has recently come to fruition is that of autonomous vehicle control, i.e., self-driving vehicles. Researchers have been developing the mechanical structures, computerized control systems, and data collection techniques that allow for smart systems in vehicles to drive the vehicle with either minimal, or preferably zero, human involvement. One subject of this research has involved ways that vehicle engineering can take advantage of currently used systems for adaptive front steering (AFS) and take such steering technology to a new level of autonomous driving. In today's vehicles, adaptive front steering (AFS) includes numerous mechanisms and programmed computers connected to or positioned within the steering assembly of a vehicle to control the steering column and shafts that directly influence vehicle wheel direction.

Traditionally, AFS has provided certain benefits within a steering system, such as, but not limited to, adding or subtracting a steering overlay angle to the steering shaft while the driver is actively turning the vehicle in one direction or the other. The driver's steering input plus (or minus) the motor's overlay angle equals the total steering angle. The total angle at which the vehicle wheels actually turn can be greater than or less than the driver steering input based on vehicle speed and other variables. The use of an overlay angle accommodates more options in making power steering systems that require less effort from a driver and more automation in controlling the driven wheels of the vehicle.

It is notable, however, that modern electric power assisted steering (EPAS) has had to overcome certain obstacles in development. For example, if the overlay angle from the power steering motor is applied while the driver is not holding the steering wheel, the steering wheel would rotate around the steering shaft, preventing future use of the steering wheel when the driver prefers to manually control rotating of the tires. In other words, when a steering system utilizes adaptive front wheel steering such that a power steering motor adds and subtracts an overlay angle to a driver's steering wheel torque input, the tendency of the system is for the combined torque output to return back to the steering wheel instead of traversing the intended path toward the steering gearbox and vehicle wheels. To prevent such back-torque on the steering wheel, a driver utilizing manual steering typically holds the steering wheel so that the input forces intended to control steering actually affect the vehicle wheels and are not returned back to the steering wheel. In this regard, during manual steering, the only mechanism holding the steering wheel as a fixture to deflect or resist back torque is the driver's hand holding the steering wheel.

Engineering systems for fully autonomous driving that take advantage of today's known adaptive front steering (AFS) systems must account for ways to remove the driver's role in holding the steering wheel to account for backward torque thereon. By today's standards, to use adaptive front steering for autonomous driving, the driver would have to hold the steering wheel and counteract the steering torque during autonomous mode. This would cause driver fatigue and vehicle instability.

A need exists in the field of steering assemblies and related systems for a mechanism and associated control electronics that can allow a driver to completely remove the driver's hands from the steering wheel, allow a computer to control vehicle steering, and still account for any backward torque that would tend to return back up a steering column and shaft when the wheels need to turn.

### SUMMARY

In one embodiment, this disclosure describes a system of controlling an autonomous steering procedure in a vehicle with a processor configured to activate and/or deactivate each of a plurality of available modes for operating an autonomous steering program. The processor is connected to computerized memory storing computer readable commands that further configure the processor to perform computerized steps in conjunction with a steering assembly. The computer receives steering parameters from at least one vehicle sensor in data communication with the processor and further receives an autonomous steering selection input from an operator, wherein the autonomous steering selection input is transmitted to the processor to activate a first selected mode from the plurality of available modes. The computer also receives a hands-on-wheel input from a steering wheel sensor indicating whether or not the operator is in contact with a steering wheel of the vehicle. The automatic steering program generates a first decouple instruction corresponding to the first selected mode, the hands-on-wheel output indicating operator contact with the steering wheel, and the steering parameters being within a defined range. The automatic steering program then communicates the first decouple instruction to a steering control assembly to decouple torque on the steering wheel and the wheels on the vehicle.

In another embodiment, an autonomous steering system in a vehicle includes a processor connected to computerized memory and configured to execute computer implemented instructions stored in the memory. The processor is configured to receive steering parameters from at least one vehicle sensor in data communication with the processor. The autonomous steering program receives an autonomous steering selection input from an operator, wherein the autonomous steering selection input indicates whether the autonomous steering program is to be placed into an “on” mode, an “off” mode, or a “parking” mode. The computer is configured to receive a hands-on-wheel input from a steering wheel sensor indicating whether or not the operator is in contact with a steering wheel of the vehicle. The processor is further configured to generate a first decouple instruction in response to the autonomous steering selection input indicating selection of the “on” mode, the hands-on-wheel output indicating operator contact with the steering wheel, and the steering parameters being within respectively defined ranges. The computer communicates the first decouple instruction to a steering control assembly configured to decouple the steering wheel and the wheels on the vehicle and control vehicle steering with the autonomous steering program.

A third embodiment of this disclosure includes a system that implements autonomous steering in a vehicle with a processor connected to computerized memory and configured to execute computer implemented instructions stored in the memory, the processor configured to receive an autonomous steering selection input from an operator, wherein the autonomous steering selection input indicates whether the autonomous steering program is to be placed into an “on” mode, an “off” mode, or a “parking” mode. The processor further receives steering parameters from at least one vehicle sensor in data communication with the processor and receives a hands-on-wheel output from a steering wheel sensor indicating whether or not the operator is in contact with a steering wheel of the vehicle. With this data, the processor generates a first decouple instruction in response to the autonomous steering selection input indicating selection of “parking” mode, the hands-on-wheel output indicating operator contact with the steering wheel, and the steering parameters being within a defined range. The processor communicates the first decouple instruction to a steering control assembly to decouple the steering wheel and the wheels on the vehicle and control vehicle steering with the autonomous steering program.

### BRIEF DESCRIPTION OF THE DRAWINGS

Features, aspects, and advantages of the present invention will become apparent from the following description and the accompanying exemplary embodiments shown in the drawings, which are briefly described below.

FIG. 1 is a PRIOR ART perspective view of a steering assembly incorporating steering wheel sensors and a steering computer within a vehicle cabin.

FIG. 2 is a PRIOR ART front elevation view of a steering wheel and associated steering computer as set forth in FIG. 1.

FIG. 3 is a PRIOR ART front elevation view of a steering wheel incorporating the sensors of FIG. 1 entirely around the body of the steering wheel.

FIG. 4 is a PRIOR ART schematic view of a steering wheel incorporating both a hands-on-wheel sensor and appropriate electronics for powered heating of the steering wheel.

FIG. 5 is a perspective view of a steering assembly incorporating the autonomous driving components and associated control system of this disclosure.

FIG. 6 is a side elevation view of a steering assembly as set forth in FIG. 5 communicating with a computerized steering control system implementing autonomous driving as set forth in this disclosure.

FIG. 7A is a side elevation view of the steering assembly as set forth herein utilizing a solenoid as described below for steering wheel control in autonomous driving.

FIG. 7B is a side elevation view of the steering assembly as set forth herein utilizing a solenoid actuating a tooth assembly as described below for steering wheel control in autonomous driving.

FIG. 7C is a side elevation view of the steering assembly as set forth herein utilizing a solenoid actuating the tooth assembly of FIG. 7B to a locked position as described below for steering wheel control in autonomous driving.

FIG. 7D is a side elevation view of the steering assembly as set forth herein utilizing a solenoid actuating the tooth and spring assembly as described below for steering wheel control in autonomous driving.

FIG. 7E is a side elevation view of the steering assembly as set forth herein utilizing a solenoid actuating the tooth and spring assembly as described below for steering wheel control in autonomous driving.

FIG. 8A is a side elevation view of the steering assembly as set forth herein utilizing a solenoid to control a clutch assembly as described below for steering wheel control in autonomous driving.

FIG. 8B is a side elevation view of the steering assembly as set forth herein utilizing a solenoid actuating a tooth assembly to control a clutch assembly as described below for steering wheel control in autonomous driving.

FIG. 8C is a side elevation view of the steering assembly as set forth herein utilizing a solenoid actuating the tooth assembly of FIG. 8B to a locked position to control a clutch assembly as described below for steering wheel control in autonomous driving.

FIG. 8D is a side elevation view of the steering assembly as set forth herein utilizing a solenoid actuating the tooth and spring assembly as described below to control a clutch assembly for steering wheel control in autonomous driving.

FIG. 8E is a side elevation view of the steering assembly as set forth herein utilizing a solenoid actuating the tooth and spring assembly to control a clutch assembly as described below for steering wheel control in autonomous driving.

FIG. 9 is a schematic view of software logic in flowchart form to implement the embodiments of FIGS. 5-8 for autonomous driving in one selected mode.

FIG. 10 is a schematic view of software logic in flowchart form to implement the embodiments of FIGS. 5-8 for autonomous driving in a second selected mode.

FIG. 11 is a side elevation view of a steering assembly communicating with a computerized steering control system implementing autonomous driving utilizing a fixed steering drive shaft as set forth in this disclosure.

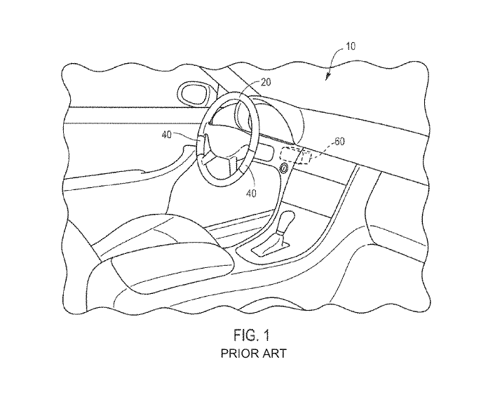

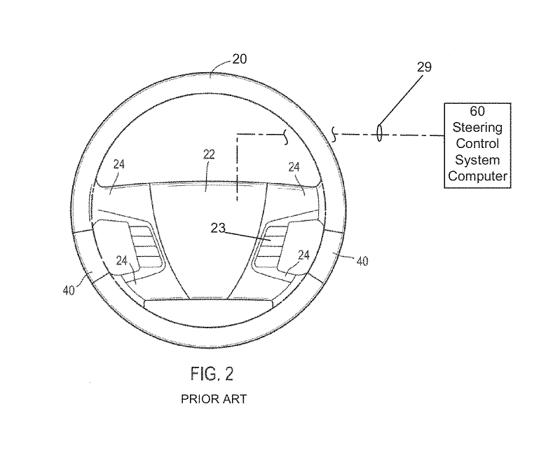

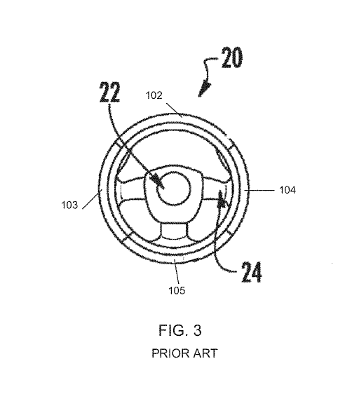

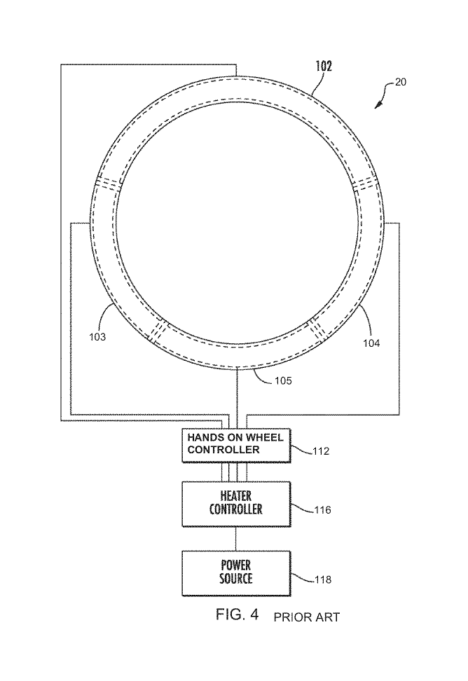

### DETAILED DESCRIPTION

Terms in this disclosure are intended to have their broadest plain meaning as used context. That said, this disclosure describes systems, methods, and apparatuses that implement autonomous steering in a vehicle while simultaneously providing appropriate steering wheel positioning. The computerized aspects of this disclosure provide a driver with steering functionality having selectable modes that take effect at the option of the driver. As used herein, a period of time in which a certain mode for autonomous steering has been selected and remains active is referred to as a “driving cycle” for that autonomous steering mode. In one non-limiting example, a driving cycle, therefore, begins with a user selecting a mode, and the driving cycle ends when an overriding control system in a computer ends the selected mode or when the driver ends the selected mode by choosing a different option on a mode panel in the vehicle. It is to be understood that both the foregoing general description and the following detailed description are exemplary and explanatory only.

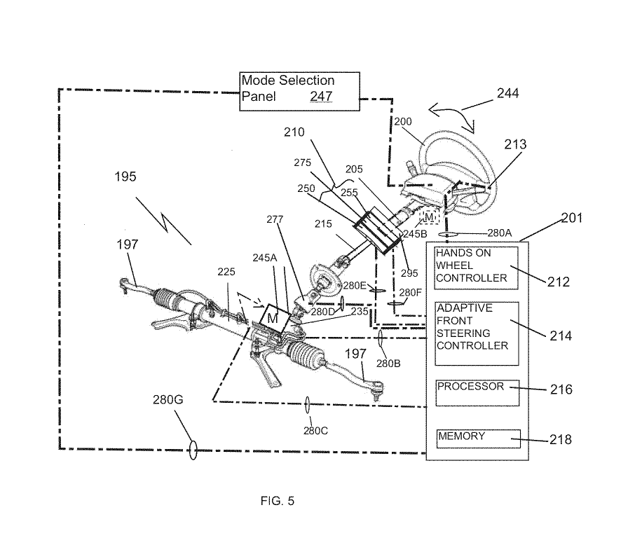

In one embodiment, a system for controlling an autonomous steering procedure in a vehicle incorporates the general steering assembly (195) shown in FIG. 5 with a steering wheel (200) ultimately connected to tie rods (197), via a system of shafts (205, 215) and a gearbox (225), by which the steering wheel adjusts vehicle wheel position and driving direction. In a traditional steering operation, the driver applies torque to the steering wheel (200), and the torque is transferred, via an outer shaft (205) connected to the steering wheel (200), to an inner shaft (215) that connects to the outer shaft (205) at one end and a gear box (225) at the other end. A system of universal joints (277) connecting the inner shaft (215) to the gearbox (225) directs the applied steering forces to the gear box (225) controlling the vehicle wheel direction. As noted above, a computer (201) having at least one processor (216) and associated computerized memory (218) may be included in the vehicle and in electronic data communication with numerous sensors and/or mechanical components within the steering assembly (195). In various embodiments of this disclosure, the computer (201) may be one of several “smart” devices having data processing and bidirectional telecommunications abilities in an overall vehicle and vehicle accessory control system. Other embodiments may implement the computer (201) with particular computer programs executing computerized software, logic, and instructions that are directed more particularly to steering operations in the vehicle. For example, the steering operations in the vehicle may include a hands on wheel (HOW) controller (212) programmed to provide automated sensing and identification of a driver's hands in contact with a particular region of the steering wheel (200) embodying hands-on-wheel sensors (213) thereon. The hands-on-wheel data (280A) is, therefore, available to the computer (201) for logical data operations used for vehicle control.

The steering assembly of FIG. 5 may also incorporate updated developments in both electronic power assisted steering (EPAS) and adaptive front steering (AFS) to achieve a level of accuracy in automatic steering to realize autonomous driving operations in self-driving vehicles. In this regard, FIG. 5 shows that the computerized control systems herein utilize the computer processor (216) and memory (218), or multiples thereof, to assimilate steering data into the vehicle control systems for a more accurate approach to real time autonomous steering. As shown in the figures, EPAS, AFS and HOW operations in a steering environment incorporate at least one power steering motor (245A, 245B) for power steering operations and the above mentioned steering angle correction. FIG. 5 illustrates that the power steering motor (245A) may be positioned adjacent the gear box (225), or in other embodiments, the power steering motor (245B) may be closer to the steering wheel (200) (i.e., in the steering column). Nothing in FIG. 5 should be considered limiting of the motor positions for the power steering motor, which can be located at any points between the illustrated motor positions (245A) and (245B) or elsewhere in the vehicle. Overall, the computer (201) is shown as receiving inputs (280A, 280B, 280G) from sensor components of the steering system (195), i.e., the hands on wheel sensor (213/280A), the torque sensor (235/280B), and the mode selection panel (247/280G) respectively. The various controllers and processors installed in the vehicle control network direct outputs to steering components as well (i.e., output (280C) to the power steering motor (245)).

With the above noted steering assembly (195) as a backdrop, the embodiments of this disclosure increase the accuracy and reliability of autonomous steering by coordinating computerized steering functions with adaptive front steering (AFS), hands-on-wheel (HOW) detection, and electronic power assisted steering (EPAS). As noted above, one issue to be addressed (without limiting the disclosure in any way) is that of steering wheel alignment during periods of autonomous steering controlled by the computer (201) instead of the driver's hands on the wheel. With the goal being to allow for torque input to the gearbox (225) and ultimately the vehicle wheels, while simultaneously controlling steering wheel (200) position and alignment, the embodiments of the system described herein provide a steering control assembly (210) illustrated by several components collectively indicated with the bracket (210) of FIG. 5.

The steering control assembly (210) connects the shafts (205, 215) of the steering assembly (195) to each other in a manner that accommodates both manual steering control by the driver using and holding the steering wheel (200) and autonomous steering with a computerized control system (201). In effect, the steering control assembly (210) mechanically connects and disconnects the steering wheel (200) from the overall steering operation and ensures that the steering wheel position is held in a properly functional place and angular orientation (244) about the shafts, without being held by the driver, allowing for safe use after autonomous steering ends. As discussed below, the steering control assembly (210) incorporates a brake in one embodiment, and the brake (275) holds the steering wheel stationary when a decouple instruction (280E) from the computer (201) causes the outer shaft (205) and the inner shaft (215) to decouple so that the computer instead of the steering wheel controls steering torque on the inner shaft (215). Of course, when the outer shaft (205) and the inner shaft (215) are coupled, the driver can utilize manual steering as in an ordinary vehicle. Even manual steering, however, still benefits from adaptive front steering as discussed herein.

In one embodiment, the steering control assembly (210) includes a clutch assembly (250, 255) that attaches and releases an inner shaft (215), connected to the vehicle wheels, and an outer shaft (205) connected directly to the steering wheel (200). The steering control assembly (210), therefore, uses a clutch assembly (250, 255) having a driven plate (250) and a pressure plate (255). The pressure plate (255) is connected to the outer shaft (205) of the steering assembly, which is, in turn, connected directly to the steering wheel (200) and/or a steering wheel motor (245A, 245B). In other words, the steering wheel (200) and the outer shaft (205) move as one unit during manual steering operations to operate as a torque input device from the driver to the pressure plate (255). This torque input may be conferred onto the pressure plate (255) in conjunction with the steering wheel motor (245) adjusting an overlay angle as discussed above. The driven plate (250) is coupled with and is configured to turn the inner shaft (215) that is connected to the gearbox (225). During manual steering, the driven plate directs torque from the steering wheel (200) and/or the steering wheel motor (245) (for overlay angle purposes) to the gearbox (225) and ultimately to the vehicle wheels. During manual steering, spring assemblies place the pressure plate (255) and the driven plate (250) in frictional contact as a default position for each plate (250, 255) (i.e., the springs are biased to place the pressure plate and the driven plate in direct contact). When the driver turns the steering wheel (200) during vehicle operation, the outer shaft (205) turns accordingly, along with the pressure plate (255) of the steering control assembly (210), which in this example is a clutch assembly (250, 255). Because of the frictional connection between the plates (250, 255), the torque from the steering wheel (200) is directed down both the outer shaft (205) and the inner shaft (215) to the gear box (225), and the input torque may be altered as discussed above by the power steering motor (245) receiving commands from the adaptive front steering controller (214) in communication with the torque sensor (235) and other sensors in the system.

The assembly (195) of FIG. 5 also accommodates using the steering control assembly (210) to enable autonomous steering by separating the pressure plate (255) and the driven plate (250) so that the computer (201) controls movement of the inner shaft (215) and the torque thereon, also in conjunction with the steering wheel motor (245) under the control of the adaptive front steering controller (214). In other words, the clutch assembly (250, 255) may be released from the frictional contact between the pressure plate (255) and the driven plate (250) when autonomous driving is selected by the driver as a mode of vehicle operation. During autonomous steering, therefore, the clutch assembly (250, 255) releases the plates so that the steering wheel (200) is disconnected from the gear box (225) and the vehicle wheels. The computer controls the steering wheel motor (245), the combination of which drives the vehicle and provides the steering torque via computerized instructions executed by a processor (216) in conjunction with an autonomous steering program.

The computer (201) is disclosed as receiving numerous inputs (i.e., hands on wheel data (280A), torque sensor data (280B), power steering motor data (280C), and mode selection data (280G) from a user selection panel in the vehicle cabin). The user's mode selection data may be the result of a user manually selecting options from a panel (247) of switches and buttons in the vehicle cabin, or the vehicle may accommodate voice data commands and other forms of enhanced data input from the driver. These inputs, among others as necessary, allow for autonomous steering by which the computer (201) controls the inner shaft (215) directing controlled torque to the gearbox (225) via the power steering motor (245). Autonomous steering may also be paired with GPS systems that allow for self-driving vehicle functionality in a variety of formats by steering the vehicle in accordance with digital mapping services, pre-programmed routes to preferred locations, or even real time directions received at the computer (201) via its telecommunications capabilities.

It is noteworthy that the steering control assembly (210), described as a clutch assembly (250, 255) above, also incorporates mechanical components that secure the steering wheel in a known position during autonomous steering and self-driving vehicle modes. A mechanism, such as the clutch brake (275), for securing the steering wheel (200) during autonomous driving is a replacement for the driver's hands holding the steering wheel (200) and providing an opposite force response to back torque exhibited from the vehicle wheels, where the back torque from the gearbox and vehicle wheels traverses up to the steering wheel (200) when the wheels turn via the tie rods (197). In the example of FIG. 5, during autonomous driving, the clutch's pressure plate (255) and driven plate (250) are out of contact with each other, as the computer (201) and its pre-programmed instructions steer the vehicle in conjunction with the steering wheel motor (245). One mechanism, which is not limiting of the disclosure herein, for securing the steering wheel position during autonomous driving includes a brake assembly (275) incorporated into the steering control assembly (210). A clutch brake (275) may be installed between the pressure plate and the driven plate of the clutch assembly such that when the pressure plate and the clutch plate are out of frictional contact during autonomous driving, the clutch plate (275) engages the pressure plate, and therefore the outer shaft (205), to secure the steering wheel (200) in a preferred position. The preferred position may be a centered angular position (244) intended to emulate driving the vehicle straight ahead. The centered position may be achieved by the driver before selecting autonomous steering modes or may be selected and implemented by the computer (201) automatically (i.e., by controlling the steering wheel motor (245)) before separating the clutch assembly plates (250, 255). Use of a clutch brake to fix the position of the steering wheel (200) while the computer (201) steers the vehicle can be accomplished by clutch actuating assemblies, whether mechanically, hydraulically, or pneumatically driven.

The above noted steering control assembly (210) implemented as a clutch (250, 255) and/or clutch brake (275) assembly represents examples of ways that the steering control assembly (210) may be implemented to provide options for separately controlling vehicle steering of the vehicle wheels and steering wheel control in the vehicle cabin. Although the example of FIG. 5 shows the clutch and clutch brake assembly, this disclosure encompasses embodiments by which the steering wheel (200) is connected only to a brake assembly and/or only to a clutch or other junction assembly. In all configurations, these structures control the steering wheel position in the presence of potential back-torque issues that could cause the steering wheel position to become misaligned during autonomous driving and/or automated steering correction with overlay angles.

In another embodiment along these lines, the steering wheel (200) remains coupled to the drive shaft assembly via a fixed outer shaft (205) (i.e., without the steering control assembly (210)). Instead, in one non-limiting example, the outer shaft (205) remains coupled to both the steering wheel and the inner shaft (215) at all times. In this embodiment, the outer shaft (205) is optionally fixed in a single stationary position that holds the steering wheel in a corresponding fixed position when the autonomous steering is engaged and the inner shaft (215) directs torque to the gearbox (225). Accordingly, in this example embodiment, the steering operations are controlled by the motor (245) via at least a portion of the drive shaft, while maintaining a known, aligned home position for steering wheel rotation. By connecting the outer shaft (205) and the inner shaft (215), as well as the outer shaft (205) and the steering wheel (200), with electronically controllable joint assemblies (239A, 239B), the computer operations described above (schematically represented as control system (236)) optionally fixes and releases the outer shaft (205) and/or the steering wheel (200) to accomplish an embodiment that does not require decoupling the steering wheel from the drive shaft. When a driver's hands are detected on the wheel, the motor (245) will react to allow the driver to steer normally (i.e., releasing the outer shaft (205) from a fixed position). When the driver's hands are removed to initiate autonomous steering, the computerized methods of the steering control system (236) adjust the electronically controllable joint assemblies (239A, 239B) to ensure proper torque directed to the gear box (225) and either hold the steering wheel in a fixed position with a fixed outer shaft (205) or allow the motor to rotate the steering wheel autonomously with each turn. For instances in which the motor (245) rotates the steering wheel with each turn, the electronically controllable joints (239A, 239B) connecting the steering wheel to the drive shaft (or outer shaft (205)) can be subject to a computerized control algorithm implemented by the control system (236) that re-centers the steering wheel as appropriate when the driver chooses to reassume manual steering.

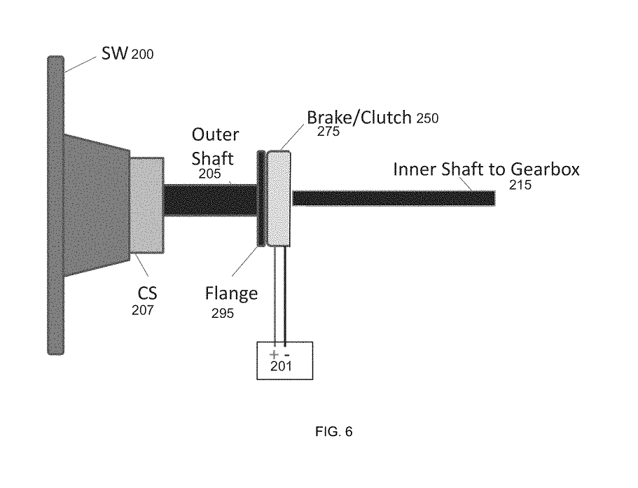

FIG. 6 illustrates a closer view of the steering wheel (200) and shaft assemblies (205, 215) utilizing a steering control assembly (210) in the form of the above described clutch (250, 255) with a clutch brake (275). The steering control assembly (210) may be secured in the overall steering assembly by standard flange (295). The computer (201) is equipped to control peripheral actuating systems with control system (207) that enable the above-described operations to engage and disengage the clutch plates and to utilize the brake (275) to secure steering wheel position.

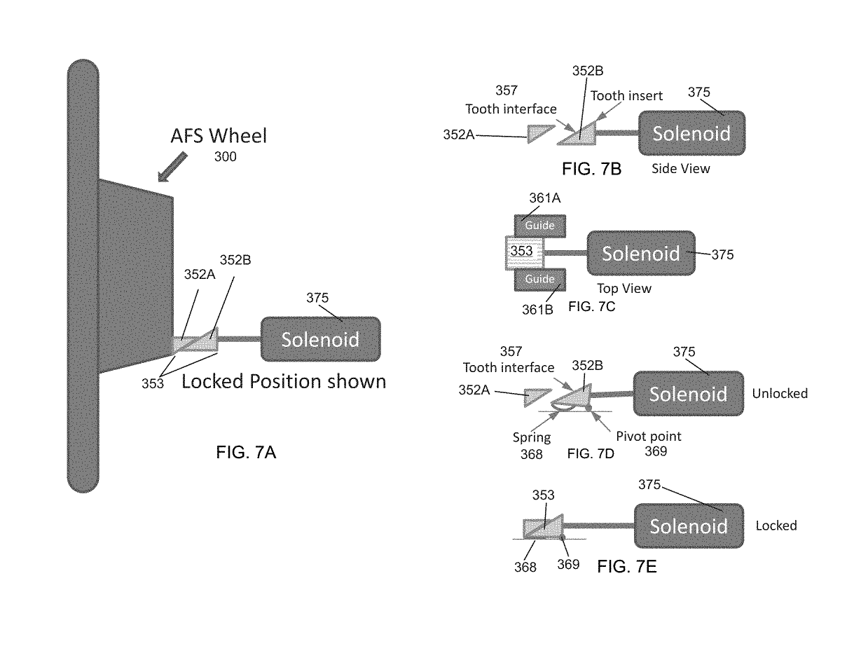

FIG. 7 includes numerous schematics of devices that may be used as actuating devices for the steering control assembly (210), whether implemented as a clutch (250, 255), a solitary brake (353) or a clutch brake (275). FIG. 7A illustrates the steering wheel (300) controlled via a computer (201) implementing an adaptive front steering control system programmed therein. In this embodiment, a solenoid (375) may be utilized to actuate a locking mechanism shown in the locked position and securing the steering wheel in a preferred position such as a centered angular position (244) from the perspective of the driver described above during autonomous steering. FIG. 7B illustrates the concept by which the solenoid (375) actuates one side of mating teeth arranged to lock the steering wheel in the preferred position when the teeth are engaged with one another (such as when a steering control assembly (210) has mechanically separated the steering wheel (300) from the wheels of the vehicle). In this arrangement, a locked position for the mating teeth (352A, 352B) is achieved by the solenoid (375) configured for control by the computer (201) to actuate and de-actuate a tooth insert (352B) to position the tooth insert 352B in engagement with a receiving tooth (352A) via a tooth interface (357) secured to either the steering wheel (300) or an outer shaft as described above. FIG. 7C illustrates that a mating teeth arrangement may fit within guides (361A, 361B) secured to either the steering wheel or other fixed structures in the steering assembly (195) so that the receiving tooth (352A), the tooth insert (352B), and the tooth interface (357) slide directly in and out of engagement as the solenoid is actuated and de-actuated by the computer (201). FIG. 7C also illustrates that the guides (361A, 361B) provide a track in which the mating teeth travel and in which, upon mating, are resistant to torque that may be input to the steering wheel even during autonomous driving operation.

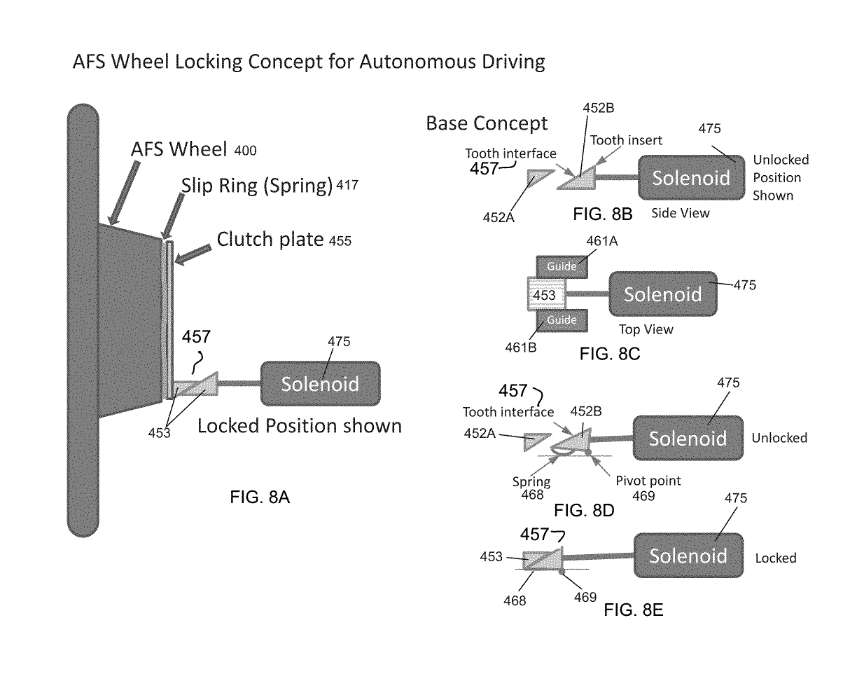

A further enhancement to the mating teeth construction of FIGS. 7A-7C is illustrated in FIGS. 7D and 7E by which the mating teeth achieve the locked arrangement (353) of FIG. 7E with more accuracy and reliability. As shown in FIG. 7D, the tooth interface (352B) may be fitted with a pivot point (or a fulcrum) (369) on a proximate end relative to the solenoid (375) and a spring (368) at its end relative to the solenoid. The fulcrum (369) and the spring (368) ensure that a small amount of pivoting on the tooth interface helps the mating teeth avoid a peak to peak collision of sorts by which the tooth insert and the receiving tooth engage via a tooth interface instead of being stuck by a peak to peak meeting of the teeth that does not provide a secure connection that locks the steering wheel. FIG. 8 illustrates the same idea as the features of FIG. 7, but in FIG. 8, the mating teeth (457), actuated by the solenoid (475) move the clutch pressure plate (positioned against slip ring 417) described above out of frictional contact with the clutch driven plate and locks the steering wheel simultaneously. This configuration is an alternative to the above described clutch brake (275).

The above noted computer (201) has been described as incorporating a processor (216) and memory (218) that implement non-transitory computer readable media storing computerized software instructions that implement programmed logic to utilize autonomous steering as described above. In one embodiment, the computer (201) and the steering assembly (195) of FIG. 5 are configured to execute a system of controlling an autonomous steering program in a vehicle. A processor (216) is configured to activate and/or deactivate each of a plurality of available modes for operating the autonomous steering program. The processor (216) is connected to computerized memory (218) storing computer readable commands that further configure the processor to perform computerized steps that configure and enable autonomous steering for the vehicle. Numerous inputs from the driver and vehicle sensors positioned throughout the vehicle are compiled at the computer (201). Vehicle sensors, such as torque sensor (235) among others, calculate and transmit steering parameters from at least one vehicle sensor in data communication with the processor. The steering parameters include but are not limited to data regarding at least one of vehicle speed, front wheel position, front wheel rotation angle, steering wheel position, steering wheel rotation angle, torque input, vehicle direction, seat belt status, tire inflation, and vehicle suspension activity. As shown in FIG. 5, the autonomous steering computer program and system described herein may be implemented with options for a user who is driving the vehicle to select and deselect operation modes for the vehicle, including but not limited to manual steering, autonomous steering, highway/interstate operation, surface street operation, parking options, and other pre-programmed options that are feasible and that consumers may require of a manufacturer. In the example of FIG. 5, which is non-limiting in terms of its disclosure, the vehicle driver may access a mode selection panel (247) from within the vehicle, and the panel may be configured for activation by touch screens, push buttons, or voice commands from the driver. The modes of operation that are available to the driver may be illustrated on the panel in words, images, interactive touch screens, and the like. Nothing herein limits the visual indicators that may be implemented on the touch screens to show a driver the modes of operation. For example, the modes of vehicle operation shown on the mode selection panel (247) may reflect autonomous steering options for highway driving that is significantly straight and at higher speeds, surface road driving that involves turns and more curves in the road, or parking mode that allows a vehicle to park itself safely and reliably. The mode selection panel (247) may also have options for turning the autonomous driving program on and off, where an off status indicates manual steering by the vehicle operator using the steering wheel (200). These modes and options for the mode selection panel are examples of implementations that may be available for a driver to use autonomous steering programs and/or select manual steering in driving, but none are limiting of the disclosure discussed herein. Overall, the computer (201) is configured to be in bi-directional electronic communication with the steering assembly (195) and the mode selection panel (247). The computer (201) receives an autonomous steering selection input (280G) from the mode selection panel (247) used by the driver, and the selection input is transmitted to the processor to activate a first selected mode from the plurality of modes. The computer (201) also receives a hands-on-wheel input (280A) from a steering wheel sensor (102, 103, 104, 105, 213) indicating whether or not the operator is in contact with a steering wheel (200) of the vehicle to a sufficient extent that the computer can reliably consider the vehicle steering wheel under manual control. From the various inputs described above, the computer (201) implements an autonomous steering program that generates a first decouple instruction corresponding to a first selected mode indicated by the panel (247), the hands-on-wheel input (280A) indicating operator contact with the steering wheel (200), and the steering parameters being within respectively defined ranges. The computer (201) and its preprogrammed autonomous driving software are configured to communicate the first decouple instruction to a steering control assembly (210), to decouple torque applied to the steering wheel (200) and the wheels on the vehicle. Upon decoupling, the vehicle enters an autonomous driving mode by which the computer (201) controls steering operations. The decoupling operation has been described above in regard to an example where the coupling and decoupling of the steering control assembly is accomplished with a clutch (250, 255). The mechanical discussions above are therefore implemented with the software steps described here as being implemented by a computer.

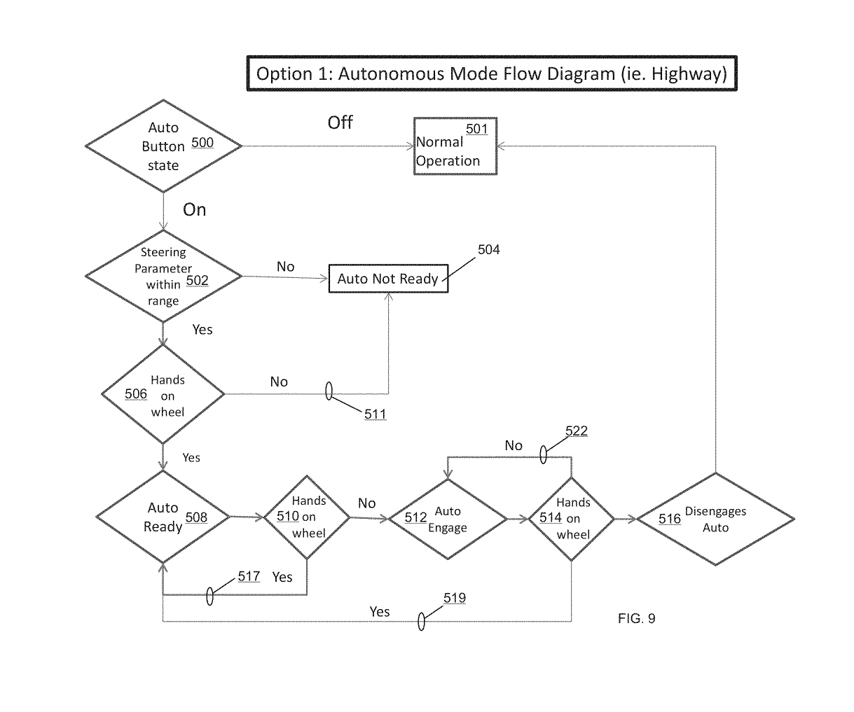

Decoupling the steering wheel (200) from the wheels of the vehicle has been explained herein as decoupling an outer shaft (205) and an inner shaft (215) so that torque applied to the steering wheel is not transmitted to the inner shaft connected to the gearbox (225) and ultimately the vehicle wheels. FIG. 9 illustrates one example of how the autonomous steering operations in a vehicle may be implemented in software logic. The logic of the flowcharts attached here are not limiting of the disclosure and represent examples of software steps and instructions that may be used by a vehicle control system to enact autonomous driving. As discussed above, the autonomous steering control program installed on the computer (201) checks the above-described sensor and selection inputs including an auto-steering input (500) from the selection panel (247), performs a confirmation check on steering parameters against preferred ranges for each (502) and determines that the vehicle is operated by a driver whose hands are on the wheel (506) as indicated by a hands on wheel sensor (213). FIG. 5 illustrates communications necessary to accommodate all control functions described herein (280A, 280B, 280C, 280D, 280E, 280F, 280G).

Prior to communicating the first decouple instruction, the processor (216) determines an autonomous steering “not ready state” upon receiving at least one command that the autonomous steering program selection input (280G) indicates an “off” mode, the hands-on-wheel output indicates the operator is not in contact with the steering wheel, or any of the steering parameters is outside of a defined range. Any of these commands (280) prevents the processor from communicating any decouple instructions to the steering control assembly (210) when the “not ready state” is determined. FIG. 9 illustrates one kind of autonomous steering operation available, for example during highway driving. In the flowchart of this example embodiment, when the computer (201) receives an autonomous steering program mode input (280G) equal to “on” and after communicating a first decouple instruction (280E) to the steering control assembly (210), the processor (216) places the autonomous steering computer program stored in the memory (218) into a continuous autonomous steering ready state in which the hands-on-wheel signal (280A) received by the processor (216) toggles the decouple instruction on and off. In other words, when the computer receives appropriate inputs indicating that autonomous steering has been selected and the vehicle operation is appropriate, such as for highway driving, the autonomous steering program may hold the autonomous steering program in a ready state during a driving cycle on a highway. As shown at logical blocks 508, 510, and 517 of FIG. 9, when the autonomous driving program is “on” and the vehicle is meeting appropriate conditions for autonomous steering, the autonomous driving program remains in an “auto-ready” state until the driver affirmatively disengages autonomous steering at logical block (516). During an auto-ready state (508), the driver may implement autonomous driving and manual steering back and forth as necessary or desired without the system requiring the driver to start all the way over with another mode selection at the mode selection panel (247). The parameters discussed above, however must remain in appropriate states to merit such toggling back and forth. FIG. 9, therefore, illustrates that when conditions are appropriate, the autonomous steering mode disclosed herein implements the continuous autonomous steering ready state (508) that is maintained so long as the driver has hands on the steering wheel (510, 517) even before the computer (201) implements autonomous steering mode. So long as auto-ready (508) is maintained with appropriate prerequisite conditions met, the auto-steering may be utilized and the computer may steer the vehicle so long as the driver's hands remain off the wheel (522) as indicated by the HOW sensors (102, 103, 104, 105, and 213). Due to the continuous nature of the autonomous steering ready state (508) illustrated at FIG. 9, even when the driver places hands on the wheel (514) while autonomous steering is underway, the computer (201) remains in an autonomous steering ready state (508, 519) allowing the driver to implement autonomous steering again during the same driving cycle (i.e., during periods in which the user selection at the panel (247) stays the same, typically but not limited to “on” in this scenario). The continuous autonomous steering ready state, therefore, may be programmed to accommodate switching between autonomous steering when the decouple instruction toggles “on” and manual steering when the decouple instruction toggles “off” in one driving cycle.

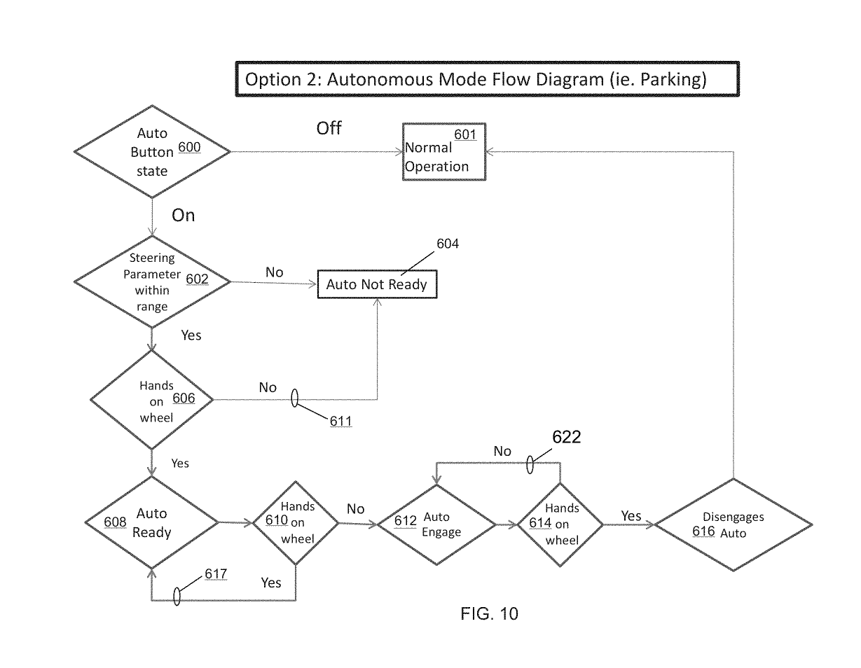

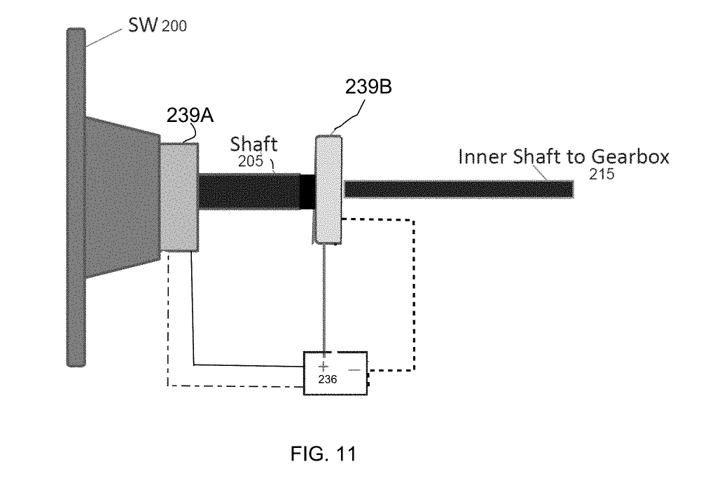

FIG. 10 illustrates a different embodiment of the autonomous steering program logic. In FIG. 10, for an autonomous steering program mode equal to “parking” (selected from the mode panel (247)) and after sending the first decouple instruction to the steering control assembly (210), the processor (216) places the autonomous steering program into a discrete autonomous steering ready state (608) for a period determined by a time lapse beginning with the first decouple instruction and ending with the “hands-on-wheel” output (610) indicating operator contact with the steering wheel. Unlike the autonomous driving protocol of FIG. 9, in this parking mode, the hands on wheel sensor determines the period in which autonomous mode ready state is on and available for use. In the event that the driver places hands on the steering wheel to control steering (614), the hands on wheel status (614) disengages (616) the autonomous steering operation and requires the driver to start over with a new selection from the selection panel (247).

The autonomous steering program described herein has numerous advantages that are apparent from the above discussion. The program works with currently manufactured adaptive front steering mechanisms and software to seamlessly apply and remove offset/overlay angles during normal driving and incorporate that functionality into autonomous steering as well. The system described here is adaptable to external vision sensing systems communicating with the vehicle control programs as well as other steering accessories, such as a light bar and vibration can be added to the steering wheel (or any other location), visual, tactile and audible feedback warns the driver to take over steering.

For purposes of this disclosure, the term “coupled” means the joining of two components (electrical, mechanical, or magnetic) directly or indirectly to one another. Such joining may be stationary in nature or movable in nature. Such joining may be achieved with the two components (electrical or mechanical) and any additional intermediate members being integrally defined as a single unitary body with one another or with the two components or the two components and any additional member being attached to one another. Such joining may he permanent in nature or alternatively may be removable or releasable in nature.

The present disclosure has been described with reference to example embodiments, however persons skilled in the art will recognize that changes may be made in form and detail without departing from the spirit and scope of the disclosed subject matter. For example, although different example embodiments may have been described as including one or more features providing one or more benefits, it is contemplated that the described features may he interchanged with one another or alternatively he combined with one another in the described example embodiments or in other alternative embodiments. Because the technology of the present disclosure is relatively complex, not all changes in the technology are foreseeable. The present disclosure described with reference to the exemplary embodiments is manifestly intended to be as broad as possible. For example, unless specifically otherwise noted, the exemplary embodiments reciting a single particular element also encompass a plurality of such particular elements.

Exemplary embodiments may include program products comprising computer or machine-readable media for carrying or having machine-executable instructions or data structures stored thereon. For example, the sensors and heating elements may be computer driven. Exemplary embodiments illustrated in the methods of the figures may be controlled by program products comprising computer or machine-readable media for carrying or having machine-executable instructions or data structures stored thereon. Such computer or machine-readable media can be any available media which can be accessed by a general purpose or special purpose computer or other machine with a processor. By way of example, such computer or machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of computer or machine-readable media. Computer or machine-executable instructions comprise, for example, instructions and data which cause a general purpose computer, special purpose computer, or special purpose processing machines to perform a certain function or group of functions. Software implementations of the present disclosure could be accomplished with standard programming techniques with rule based logic and other logic to accomplish the various connection steps, processing steps, comparison steps and decision steps.

It is also important to note that the construction and arrangement of the elements of the system as shown in the preferred and other exemplary embodiments is illustrative only. Although only a certain number of embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the assemblies may be reversed or otherwise varied, the length or width of the structures and/or members or connectors or other elements of the system may be varied, the nature or number of adjustment or attachment positions provided between the elements may be varied. It should be noted that the elements and/or assemblies of the system may be constructed from any of a wide variety of materials that provide sufficient strength or durability. Accordingly, all such modifications are intended to be included within the scope of the present disclosure. The order or sequence of any process or method steps may be varied or re-sequenced according to alternative embodiments. Other substitutions, modifications, changes and omissions may be made in the design, operating conditions and arrangement of the preferred and other exemplary embodiments without departing from the spirit of the present subject matter.

1. A system of controlling an autonomous steering program in a vehicle, comprising:
a processor configured to activate and/or deactivate each of a plurality of available modes for operating the autonomous steering program, the processor being connected to computerized memory storing computer readable commands that further configure the processor to perform the following computerized steps:
receive steering parameters from at least one vehicle sensor in data communication with the processor;
receive an autonomous steering selection input from an operator, wherein the autonomous steering selection input is transmitted to the processor to activate a first selected mode from the plurality of modes;
receive a hands-on-wheel output from a steering wheel sensor indicating whether or not the operator is in contact with a steering wheel of the vehicle;
generate a first decouple instruction corresponding to the first selected mode, the hands-on-wheel output indicating operator contact with the steering wheel, and the steering parameters being within a defined range; and
communicate the first decouple instruction to a steering control assembly to decouple torque on the steering wheel and the wheels on the vehicle.

2. A system according to claim 1, wherein prior to communicating the first decouple instruction, the processor determines an autonomous steering “not ready state” upon receiving at least one command that the autonomous steering program selection input indicates the “off” mode, the hands-on-wheel output indicates the operator is not in contact with the steering wheel, or any of the steering parameters is outside of the defined range, and wherein the at least one command prevents the processor from communicating any decouple instructions to the steering control assembly when the “not ready state” is determined.

3. A system according to claim 1, wherein for an autonomous steering program mode equal to “on” and after communicating the first decouple instruction to the steering control assembly, the processor places the autonomous steering program into a continuous autonomous steering ready state in which the hands-on-wheel output received by the processor toggles the decouple instruction on and off.

4. A system for autonomous steering according to claim 3, wherein the continuous autonomous steering ready state accommodates switching between autonomous steering when the decouple instruction toggles “on” and manual steering when the decouple instruction toggles “off” in one driving cycle.

5. A system according to claim 1, wherein for an autonomous steering program mode equal to “parking” and after sending the first decouple instruction to the steering control assembly, the processor places the autonomous steering program into a discrete autonomous steering ready state for a period determined by a time lapse beginning with the first decouple instruction and ending with the “hands-on-wheel” output indicating operator contact with the steering wheel.

6. A system according to claim 1, further comprising a brake that holds the steering wheel stationary when the first decouple instruction is sent to the steering control assembly.

7. A system according to claim 1, wherein the steering control assembly is a clutch assembly selectively operable to couple or decouple an inner steering shaft providing torque to the wheels and an outer steering shaft connected to the steering wheel, wherein autonomous steering is initiated when said outer steering shaft is decoupled from said inner steering shaft.

8. A system according to claim 7, wherein the steering control assembly comprises a brake assembly selectively operable to hold said outer steering shaft and said steering wheel stationary upon receiving a decouple instruction.

9. A system according to claim 7, wherein the steering control assembly comprises a solenoid actuator configured to selectively engage the outer shaft and the steering wheel and secure the steering wheel in a stationary position upon receiving a decouple instruction.

10. A system according to claim 9, wherein said solenoid actuator controls a piston having a tooth insert on a first end, said tooth insert configured to match a receiving tooth on the outer shaft, and wherein mating the tooth insert and the receiving tooth secures the steering wheel in a stationary position.

11. A system according to claim 10, wherein said tooth insert on said piston further comprises a spring connected to the tooth insert, said spring allowing pivoting of the tooth insert along a travel path toward the receiving tooth.

12. An autonomous steering system in a vehicle, comprising:
a processor connected to computerized memory and configured to execute computer implemented instructions stored in the memory, the processor configured to:
receive steering parameters from at least one vehicle sensor in data communication with the processor;
receive an autonomous steering selection input from an operator, wherein the autonomous steering selection input indicates whether the autonomous steering program is to be placed into an “on” mode, an “off” mode, or a “parking” mode;
receive a hands-on-wheel output from a steering wheel sensor indicating whether or not the operator is in contact with a steering wheel of the vehicle;
generate a first decouple instruction in response to the autonomous steering selection input indicating selection of the “on” mode, the hands-on-wheel output indicating operator contact with the steering wheel, and the steering parameters being within respectively defined ranges; and
communicate the first decouple instruction to a steering control assembly configured to decouple the steering wheel and the wheels on the vehicle and control vehicle steering with the autonomous steering program.

13. A system according to claim 12, wherein the computer implemented instructions are further configured to continue controlling vehicle steering with the autonomous steering program until the hands-on-wheel output indicates manual steering.

14. A system according to claim 13, wherein the steering wheel sensor calculates the hands-on-wheel output to indicate manual steering upon sensing a defined level of operator contact with the steering wheel, wherein the hands-on-wheel output indicating manual steering toggles the decouple instruction to a coupling instruction, directed to the steering control assembly, that couples an inner steering shaft and an outer steering shaft of the steering control assembly.

15. A system according to claim 12, wherein the steering control assembly is a clutch assembly selectively operable to couple or decouple an inner steering shaft providing torque to the wheels and an outer steering shaft connected to the steering wheel, wherein autonomous steering is initiated when said outer steering shaft is decoupled from said inner steering shaft.

16. A system according to claim 12, wherein the steering parameters comprise at least one of vehicle speed, front wheel position, front wheel rotation angle, steering wheel position, steering wheel rotation angle, vehicle direction, seat belt status, tire inflation, and vehicle suspension activity.

17. A system according to claim 12, wherein the autonomous steering program indicates a “ready” state after receiving the autonomous steering selection input of the “on” mode, the hands-on-wheel output indicating operator contact with the steering wheel, and the steering parameters being within the respectively defined ranges, and the autonomous steering program remains in a “ready” state independently of the hands-on-wheel sensor output.

18. A system according to claim 17, wherein the “ready” state remains true when the hands-on-wheel output toggles between manual steering and autonomous steering.

19. A system that implements autonomous steering in a vehicle, comprising:
a processor connected to computerized memory and configured to execute computer implemented instructions stored in the memory, the processor configured to:
receive an autonomous steering selection input from an operator, wherein the autonomous steering selection input indicates whether the autonomous steering program is to be placed into an “on” mode, an “off” mode, or a “parking” mode;
receive steering parameters from at least one vehicle sensor in data communication with the processor;
receive a hands-on-wheel output from a steering wheel sensor indicating whether or not the operator is in contact with a steering wheel of the vehicle;
generate a first decouple instruction in response to the autonomous steering selection input indicating selection of “parking” mode, the hands-on-wheel output indicating operator contact with the steering wheel, and the steering parameters being within a defined range; and
communicate the first decouple instruction to a steering control assembly to decouple the steering wheel and the wheels on the vehicle and control vehicle steering with the autonomous steering program.

20. A system according to claim 19 after sending the first decouple instruction to the steering control assembly, the processor places the autonomous steering program into a discrete autonomous steering ready state for a period extending until the “hands-on-wheel” output toggles the decouple instruction to off and couples the steering wheel to the wheels on the vehicle.
